(19) United States
(12) Patent Application Publication
(10) Pub. No.: US 2004/0129854 A1
(43) Pub. Date: Jul. 8, 2004

(54) Foot support for essentially cylindrical elements

(76) Inventor: Hans-Jorg Schmitz, Heiligenhaus (DE)

Correspondence Address: GUDRUN E. HUCKETT DRAUDT, LONSSTR. 53, WUPPERTAL, 42289, DE

(21) Appl. No.: 10/468,466

(22) PCT Filed: Jan. 31, 2002
(86) PCT No.: PCT/DE02/00347

(30) Foreign Application Priority Data
Feb. 23, 2001 (DE) 101 08 999.6

(51) Int. Cl. F16M 11/24; F16M 13/00

(52) U.S. Cl. 248/523; 248/519; 248/188.2

(57) ABSTRACT

A foot support for profiled sections has a base member; a receptacle for the profiled section arranged in the base member; and several tensioning levers having a horizontal pivot axis and arranged about an axis of symmetry. The tensioning levers are pivotable between a rest position and a clamping position about the horizontal pivot axis. The tensioning levers have a lower lever arm positioned below the horizontal axis and an upper lever arm positioned above the horizontal pivot axis. A foot-actuated actuating element that acts on a force-transmitting element, acting on the tensioning levers for moving them into the clamping position, is provided. The force-transmitting element is a vertically adjustable ring that, when carrying out a downward movement, contacts the lower lever arms of the tensioning levers such that the lower lever arms are pivoted outwardly and the upper lever arms are pivoted inwardly into the clamping position.

The invention relates to a foot support according to the preamble of claim 1.

Such a foot support which, according to DE 39 32 473 C2, serves as a Christmas tree stand, can also be used for other purposes, for example, for posts and supports of any kind, for example, table legs, flagpoles and the like.

In the known Christmas tree stand according to DE 39 32 473 C2, the force transmitting element is a flexible connecting part, in particular, a steel cable, which is loadable by tension forces. This steel cable engages the lever arms positioned above the pivot axis of the tensioning levers, i.e., in an area through which the trunk of the Christmas tree must be inserted into the container of the Christmas tree stand. Aside from the fact that such a steel cable can catch on other components of the Christmas tree stand, such an arrangement of the steel cable also makes the insertion of the trunk into the Christmas tree stand more difficult.

The Christmas tree stand according to AT 403 542 B has a base on which two-arm tensioning levers are pivotably supported. The free ends of the tensioning levers facing away from the base are loaded by the force of springs into a clamping position in which the tree is secured while the tensioning levers, on the other hand, are moved by means of a foot pedal against the force of these springs into the open position.

It is an object of the invention to provide a foot support that, in comparison to the Christmas tree stand according to DE 39 32 473 C2, is simplified with regard to its construction as well as its handling.

The solution to this object is provided by the features according to the characterizing portion of claim 1. In that, according to the invention, the force transmitting element engages the lever arms of the tensioning levers positioned underneath the pivot axes, the access to the container receiving the post, for example, a tree trunk, remains free and open so that the insertion of the post into the container is simplified.

Additional features of the invention and the advantages derived therefrom result from the dependent claims.

The invention will be explained in more detail in the following with the aid of the drawing.

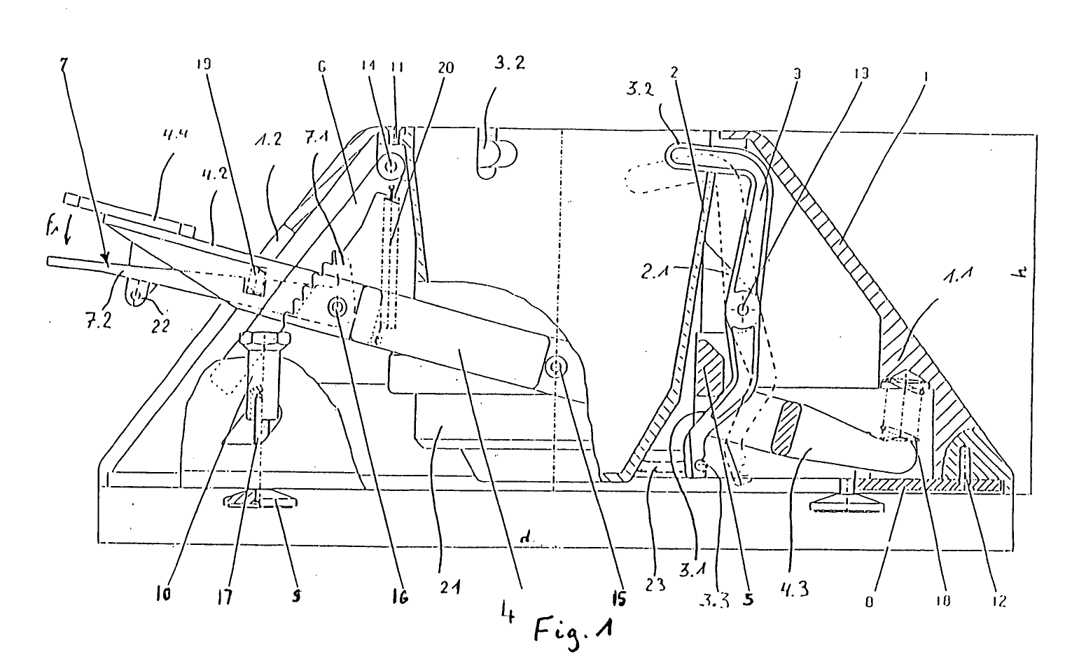

FIG. 1 shows partially in section a view of the foot support according to the invention;

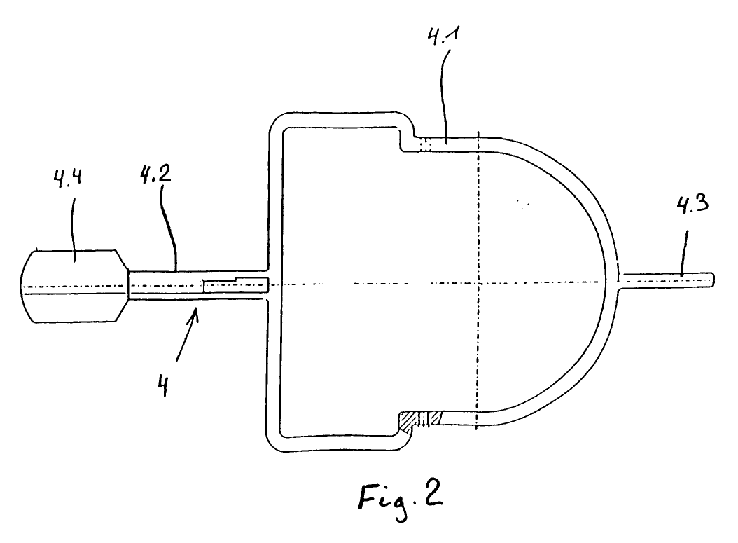

FIG. 2 shows a plan view onto the force transmitting element.

The support leg according to the invention serves for securing and fixation of particularly cylindrical posts, wherein the term post includes tree trunks, in particular, Christmas tree trunks, as well as posts in general.

The foot support is comprised of a base member 1, particularly a rotationally symmetrical one, in which a container 2 is fastened, for example, by means of screws 11, which, as illustrated, preferably tapers conically in two steps in a downward direction. On the outer wall of this container 2, which forms a receptacle for the lower end of the tree trunk or the post, holding elements in the form of twin-arm tensioning levers 3 are supported, for example, by means of support lugs 2.1, wherein the tensioning levers are pivotable about horizontal axes 13. Preferably three twin-arm levers 3 are provided which are distributed at a uniform angular spacing relative to one another. Each lever 3 has at its lower lever arm 3.1 positioned underneath the pivot axes 13 a guide section 3.1 extending slantedly downwardly from the top toward the axis of rotation of the base member 1. The lever arm of each lever 3 positioned above the pivot axes 13 has an inwardly oriented clamping or tensioning element 3.2 which projects through an opening provided in the container 2 into the interior of the container 2. In FIG. 1, the lever 3 is illustrated in solid lines in its rest position or initial position in which the upper lever arm has been pivoted back to the rear.

The lower end of the container 2 is surrounded by a stationary cylinder body 21 along whose outer wall a force transmitting element in the form of a ring 5 is slidably guided. An actuating element 4 is connected to this ring 5 by means of bearing pins 15; the actuating element is illustrated in FIG. 2 in a plan view and surrounds the ring 5. This element 4 is comprised preferably of a bracket closed on all sides and having dimensions matched substantially to the outer circumference of the ring 5 such that the actuating element 4 can be pivoted relative to the ring 5. The actuating element 4, which accordingly is configured as a pivot lever, is provided at its first end with a foot lever 4.2 having a foot pedal 4.4 and on its second end with a support lever 4.3 that has on its upper side a pressure spring 18 having a high spring stiffness and being supported with its lower end on the upper side. The upper abutment for the pressure spring 18 is formed by an inwardly oriented projection 1.1 of the base member 1. The pressure spring 18 that loads the support lever 4.3 with a downwardly oriented force and the support lever 4.3 are matched to one another with regard to their size such that the support lever 4.3 and the pressure spring 18 form a support location for the pivot lever 4 which, upon pivoting of the pivot lever 4, is moved inwardly or outwardly in the area of the support lever 4.3.

In the upper area of the container 2, optionally also in the upper area of the base member 1, a toothed rack 6 is attached by means of a bearing pin 14 which at its underside is provided with downwardly oriented ratchet-like teeth.

Between the pivot lever 4 and the toothed rack 6 a tension spring 20 is suspended such that, on the one hand, the toothed rack 6 is pulled inwardly with its teeth, i.e., in the direction of a ratchet pawl 7.1 to be described in the following, while, on the other hand, the pivot lever 4 is loaded with an upwardly oriented force.

On the foot lever 4.2 of the pivot lever 4 extending outwardly through an opening 1.2 of the base member 1, a substantially L-shaped ratchet lever 7 is attached by means of a bearing pin 16; the ratchet lever comprises a ratchet pawl 7.1 engaging the tooth gaps of the toothed rack 6 and comprises a release lever 7.2. Between the foot lever 4.2 and the release lever 7.2 of the ratchet lever 7 a pressure spring 19 is arranged such that the ratchet pawl 7.1 is loaded in the direction of the toothed rack 6. A support element 22 is arranged on the foot lever 4.2 which serves for limiting the pivot movement of the release lever 7.2, initiated by the pressure spring 19, in the downward direction.

On the underside of the base member 1 a preferably annular bottom 8 is fastened by means of screws 12. For leveling the foot support, the bottom area is provided with adjusting screws 9, 17, which cooperate with threaded nuts 10.

Each tensioning lever 3 is provided at the outer side of its lower lever arm with a notch 3.3. A schematically indicated annular spring 23 is inserted into each of the notches 3.3 of all tensioning levers 3; the annular springs maintain the tensioning levers 3 in the rest position or pull them back into the rest position. In this rest or initial position illustrated in FIG. 1, the pivot lever 4 is loaded, on the one hand, by the pressure spring 18 and, on the other hand, by the tension spring 20 such that it is pivoted upwardly, together with the foot lever 4.2 positioned outside of the base member 1; in this way, the ring 5 reaches its upper position. The tensioning levers 3 are in the position illustrated in solid lines so that, for example, the lower end of a tree trunk can be inserted into the container 2 so that the lower trunk end will be centered in the conical part of the container. Subsequently, the pivot lever 4 is pushed downwardly in the direction of arrow f1 by stepping on the foot pedal 4.4 so that the pivot lever, supported by means of the pressure spring 18, is pivoted substantially about the support location between the spring 18 and the lever end about the bearing pins 15 mounted on the ring 5 and, in this way, pushes the ring 5 downwardly so that it glides along the slantedly extending guide surfaces 3.1 of the tensioning lever 3. In this way, the tensioning levers 3 with their tensioning elements 3.2 are pivoted inwardly against the trunk end inserted into the container 2 into the contact position indicated in dashed lines. The ratchet lever 7 follows the pivot movement in the downward direction indicated by the arrow f1 wherein the ratchet pawl 7.1 glides downwardly along the teeth of the toothed rack 7 until this ratchet pawl 7.1, as a function of the thickness of the trunk or post, locks relative to one of the teeth of the toothed rack 6. It is understood that the teeth are designed such that the ratchet lever 7.1 can glide downwardly along the correspondingly designed toothed flanks during the downwardly oriented movement with simultaneous minimal lifting of the toothed rack 6.

For releasing the system for removing the tree trunk or the like, the lever arm 7.2 of the ratchet lever 7 is moved upwardly, for example, by foot actuation, against the force of the pressure spring 19 so that the ratchet pawl 7.1 is released from the toothed rack 6 such that the pivot lever 4 is pivoted upwardly by the tension spring 20, assisted by the pressure spring 18, against the direction of the arrow f1 with simultaneous entrainment of the ring 5 in the upward direction. The annual spring 23 which engages the lower ends of the tensioning lever 3 can then pivot back the tensioning levers from the tensioning position illustrated in dashed lines into the initial position illustrated in solid lines.

The clamping noses 3.2 can have, for example, the shape of clamping jaws or the like.

Of course, the foot support according to the invention, when provided with a corresponding arrangement of the tensioning levers 3, can be used for positioning upright profiled sections having a cross-section that is not round.

1. A foot support for a substantially cylindrical profiled sections comprising
a base member,
a receptacle for the profiled section arranged in the base member,
several holding elements, arranged about an axis of symmetry, in the form of twin-arm tensioning levers which are pivotable between a rest position and a clamping position about horizontal pivot axes in vertical planes which substantially intercept one another in an axis of symmetry, and
a foot-actuated actuating element engaging by means of a force transmitting element on all tensioning levers for moving them into the clamping position,
characterized in that the force transmitting element is configured as a ring (5) adjustable in the vertical direction which, by carrying out a downwardly oriented movement, can be brought into contact against the lever arms (3.1) positioned underneath the pivot axes (13) of the tensioning levers (3) such that these lower lever arms (3.1) are pivoted outwardly and, in this way, the upper lever arms (3.2) of the tensioning levers (3) are pivoted inwardly into the clamping position.

2. The foot support according to claim 1, characterized in that the lever arms (3.1) positioned underneath the pivot axes (13) have guide sections extending from above in a direction of the axis of symmetry at a slant downwardly.

3. The foot support according to claim 1, characterized in that the actuating element (4) has substantially the shape of a twin-arm pivot lever which is connected with its central area to the ring (5) and comprises a foot lever (4.2) extending outwardly from the base member (1) as well as a support lever (4.3) supported within the base member against the force of a spring.

4. The foot support according to claim 3, characterized in that the support lever (4.3) rest with the upper side of one of its lever ends against the underside of a pressure spring (18) whose upper end is supported on the base member (1).

5. The foot support according to claim 1, characterized in that each tensioning lever (3) has on its upper lever arm (3.2) an inwardly oriented clamping or tensioning element movable into the container (2) through an opening provided in the container (2).

6. The foot support according to claim 1, characterized in that the tensioning lever (3) on the outer side of its lower end is provided with notches (3.3) into which an annular spring (23) is inserted that secures the tensioning levers (3) in the rest position.

7. The foot support according to claim 1, characterized in that the actuating element (4) in its central area is comprised substantially of a bracket (4.1) closed on all sides and surrounding the ring (5) and matched such to the outer circumference of the ring (5) that the actuating element is pivotable relative to this ring.

8. The foot support according to claim 1, characterized in that the ring (5) is guided along a stationary cylindrical body (21) surrounding the container (2).

9. The foot support according to claim 3, characterized in that the foot lever (4.2) of the pivot lever (4) extending out of the base member (1) has a ratchet arrangement which enables locking of the pivot lever in different pivot positions.

10. The foot support according to claim 9, characterized in that the ratchet arrangement comprises an L-shaped ratchet lever (7) connected inside the base member (1) to the foot lever (4.2) and cooperating with a toothed rack (6) connected to the base member (1) or the container (2).

11. The foot support according to claim 10, characterized in that the ratchet lever (7) has a ratchet pawl (7.1) engaging the teeth of the toothed rack (6) and a release lever (7.2) extending out of the base member (1) and that between this release lever (7.2) and the foot lever (4.2) a pressure spring (19) is supported which forces the ratchet pawl (7.1) into engagement with the teeth of the toothed rack (6).

12. The foot support according to claim 11, characterized in that between the toothed rack (6) and the actuating element (4) a tension spring (20) is suspended such that, on the one hand, the toothed rack (6) with its inwardly oriented teeth is loaded in the direction of the ratchet pawl (7.1) and, on the other hand, the actuating element (4) is loaded with an upwardly oriented force.
